(19) United States
(12) Patent Application Publication
(10) Pub. No.: US 2020/0103646 A1
(43) Pub. Date: Apr. 2, 2020

(54) PACKAGE FOR GLASS AND A GLASS ASSEMBLY USING THE PACKAGE

(71) Applicants: HYUNDAI MOTOR COMPANY, Seoul (KR); KIA MOTORS CORPORATION, Seoul (KR)

(72) Inventors: Kwang Joon Han, Seongnam-si, Gyeonggi-do (KR); Dong Hwan Jang, Suwon-si, Gyeonggi-do (KR)

(73) Assignees: HYUNDAI MOTOR COMPANY, Seoul (KR); KIA MOTORS CORPORATION, Seoul (KR)

(21) Appl. No.: 16/196,944

(22) Filed: Nov. 20, 2018

(30) Foreign Application Priority Data
Oct. 1, 2018 (KR) 10-2018-0117094

(51) Int. Cl. G02B 27/00; G02B 26/00; G02B 7/02; B60R 11/04; H04N 5/225

(52) U.S. Cl. CPC G02B 27/0006; G02B 26/005; H04N 5/2252; B60R 11/04; H04N 5/2257; G02B 7/02

(57) ABSTRACT

A package for glass includes a housing having a coupling recess that surrounds transparent glass such that the transparent glass is coupled to the coupling recess. The transparent glass includes a glass electrode through which current flows and a surface electrode disposed along the housing. The surface electrode is formed of a conductive material. One end and an opposite end of the surface electrode are electrically connected to the glass electrode and a substrate disposed in the housing, respectively, to electrically connect the substrate and the glass electrode.

### CROSS-REFERENCE TO RELATED APPLICATION

This application claims the benefit of priority to Korean Patent Application No. 10-2018-0117094, filed in the Korean Intellectual Property Office on Oct. 01, 2018, the entire contents of which are incorporated herein by reference.

### BACKGROUND

### Field of the Disclosure

The present disclosure relates to a package in which glass through which current flows is installed and a glass assembly using the package.

### Description of the Related Art

Dust or droplets may adhere to a camera lens of a rear camera of a vehicle, which may lead to deterioration in visibility. Accordingly, a water-repellent coating applied to the camera lens or a method of cleaning the camera lens by directly spraying a cleaning solution is used to remove dust or droplets adhering to the camera lens.

Unfortunately, these methods require additional space for mounting a very large system and additional equipment management, such as replenishment of a cleaning solution or nozzle cleaning. In addition, these methods may be disadvantageous because of a high cost burden.

### SUMMARY

The present disclosure has been made to solve the above-mentioned problems occurring in the prior art, while advantages achieved by the prior art are remain intact.

An aspect of the present disclosure provides a package for glass and a glass assembly using the package.

The technical problems to be solved by the present disclosure are not limited to the aforementioned problems. Other technical problems not mentioned herein will be clearly understood from the following description by those skilled in the art to which the present disclosure pertains.

According to an aspect of the present disclosure, a package for glass includes a housing having a coupling recess that surrounds transparent glass such that the transparent glass is coupled to the coupling recess. The transparent glass includes a glass electrode through which current flows and a surface electrode formed along the housing. The surface electrode is formed of a conductive material, where one end and an opposite end of the surface electrode are electrically connected to the glass electrode and a substrate disposed in the housing, respectively, to electrically connect the substrate and the glass electrode.

According to another aspect of the present disclosure, a glass assembly includes transparent glass that includes a glass electrode through which current flows, a housing combined with the transparent glass, a substrate disposed in the housing, and a surface electrode disposed along the housing and brought into contact with the glass electrode and the substrate to electrically connect the glass electrode and the substrate.

### BRIEF DESCRIPTION OF THE DRAWINGS

The above and other objects, features, and advantages of the present disclosure will be more apparent from the following detailed description taken in conjunction with the accompanying drawings:

FIG. 1 is a front view illustrating a glass assembly using a package for glass according to an embodiment of the present disclosure;

FIG. 2 is a longitudinal sectional view illustrating the glass assembly using the package for glass according to the embodiment of the present disclosure;

FIG. 3 is a schematic perspective view illustrating the glass assembly using the package for glass according to the embodiment of the present disclosure;

FIG. 4 is an exploded perspective view illustrating the glass assembly using the package for glass according to the embodiment of the present disclosure, where glass is disconnected from the glass assembly;

FIG. 5 is a longitudinal sectional view illustrating a modified example of the glass assembly using the package for glass according to the embodiment of the present disclosure;

FIG. 6 is a longitudinal sectional view illustrating an upper portion of a glass assembly using a package for glass according to another embodiment of the present disclosure;

FIG. 7 is a plan view illustrating the glass assembly using the package for glass according to the other embodiment of the present disclosure; and

FIG. 8 is a detailed view illustrating a region adjacent to a housing protrusion of the package for glass according to the other embodiment of the present disclosure.

### DETAILED DESCRIPTION

Hereinafter, embodiments of the present disclosure will be described in detail with reference to the accompanying drawings. It should be understood that even if shown in different drawings, identical components are provided with identical reference numerals in the drawings. Furthermore, in describing the embodiments of the present disclosure, detailed descriptions related to well-known functions or configurations will be omitted when they may make subject matters of the present disclosure unnecessarily obscure.

Terms, such as “first”, “second”, “A”, “B”, “(a)”, “(b)”, and the like, may be used herein to describe components of the present disclosure. Such terms are only used to distinguish one component from another component. The substance, sequence, order, or number of these components is not limited by these terms. If a component were described as “connected”, “coupled”, or “linked” to another component, they may mean the components are not only directly “connected”, “coupled”, or “linked” but also may be indirectly “connected”, “coupled”, or “linked” via a third component.

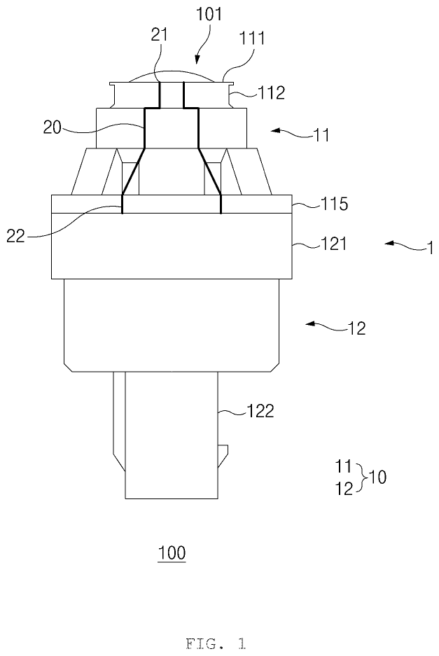

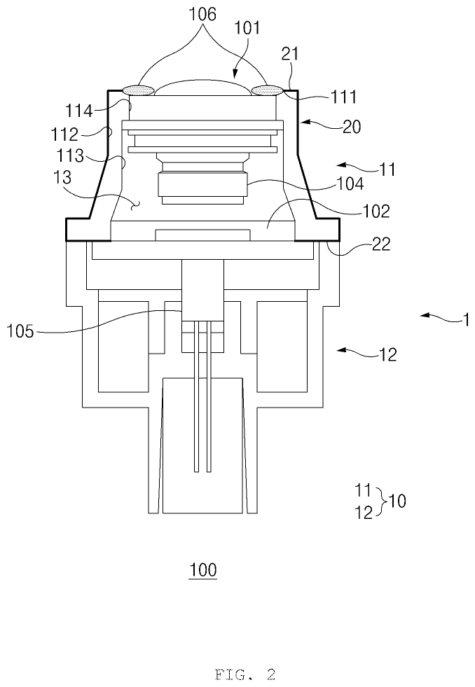

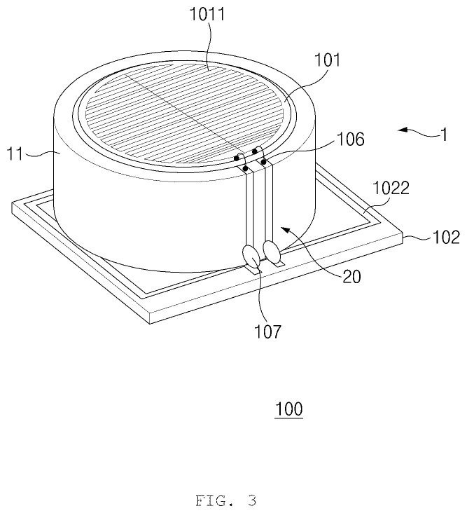

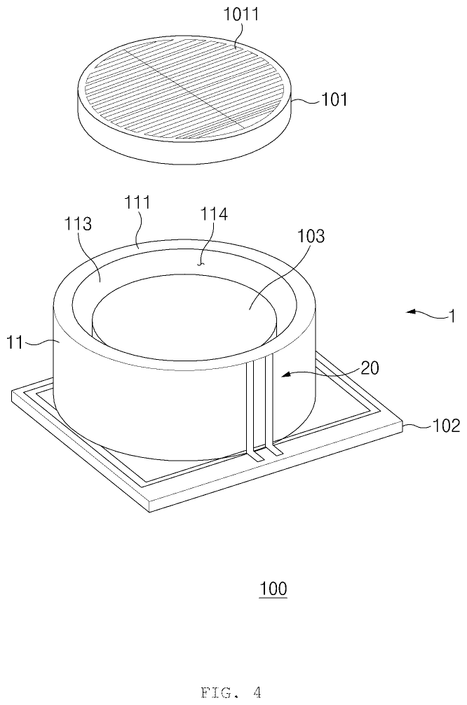

FIG. 1 is a front view illustrating a glass assembly 100 using a package 1 for glass according to an embodiment of the present disclosure. FIG. 2 is a longitudinal sectional view illustrating the glass assembly 100 using the package 1 for glass according to the embodiment of the present disclosure. FIG. 3 is a schematic perspective view illustrating the glass assembly 100 using the package 1 for glass according to the embodiment of the present disclosure. FIG. 4 is an exploded perspective view illustrating the glass assembly 100 using the package 1 for glass according to the embodiment of the present disclosure, where glass 101 is disconnected from the glass assembly 100.

Referring to FIGS. 1 to 4, the glass assembly 100 using the package 1 for glass according to the embodiment of the present disclosure includes the package 1 for glass, a substrate 102, and the glass 101. The package 1 for glass includes a housing 10 and a surface electrode 20.

The Glass 101

The glass 101 is a transparent component including a glass electrode 1011 through which current flows. The glass 101 is disposed above a lens 103 and configured to allow light to pass therethrough to reach the lens 103.

The glass 101 used in the glass assembly 100 according to the embodiment of the present disclosure may be smart glass using the electro-wetting principle. The electro-wetting principle controls surface tensions of droplets on a dielectric-coated electrode using electricity.

To use the electro-wetting principle, the glass 101 of the present disclosure may be implemented by forming an indium tin oxide (ITO) electrode thereon. The glass electrode 1011, which is an ITO electrode, may be formed on the surface of the glass 101 by coating, masking, and etching using micro-electro mechanical system (MEMS) technology. The glass electrode 1011 may be formed in a predetermined pattern without completely covering the surface of the glass 101. Specifically, the electrode pattern is formed by depositing ITO on the glass 101, coating photo-resist (PR) onto the ITO using spin coating, exposing the PR to infrared light using a mask according to a desired electrode pattern, developing the PR, and etching the ITO. The PR on the electrode pattern is removed, thereby forming the glass 101 with the predetermined pattern. Additionally, a silicon dioxide dielectric layer and a hydrophobic film made of polytetrafluoroethylene (PTFE) may be coated on the glass 101.

An electric field generated on the surface of the glass 101 by allowing current to flow through the glass electrode 1011 controls surface tensions of droplets on the surface of the glass 101 and induces micro vibration of the droplets. Consequently, the droplet adhesion to the surface of the glass 101 is decreased, thereby removing the droplets, together with dust on the surface of the glass 101, from the surface of the glass 101. Alternatively, the droplets may be attracted in a predetermined direction by electrical attraction and removed from the surface of the glass 101.

The glass electrode 1011 is formed on the surface of the glass 101 and electrically connected to the surface electrode 20, which is described below, at the outside edge of the glass 101 through an upper connecting part 106. The glass electrode 1011 is indirectly electrically connected to a circuit pattern 1022 of the substrate 102 when the surface electrode 20 is electrically connected to the circuit pattern 1022 formed on the substrate 102.

The lens 103 may be disposed below the glass 101. The lens 103 is an optical component that receives light from the outside and focuses an image on an image sensor located inside a body tube 104. The lens 103 is coupled to and protected by the body tube 104. The image sensor generates an electrical signal by capturing the image formed by the light-condensing lens 103 and transfers the generated signal to the outside through an interconnection wire 105.

The Substrate 102

The substrate 102 is disposed in the housing 10, which will be described below. The substrate 102 may be a printed circuit board (PCB). The substrate 102 may have, on the surface thereof, the circuit pattern 1022 formed of a conductive material. The substrate 102 may be electrically connected to the outside through the interconnection wire 105 and may have a microprocessor mounted thereon, which is capable of performing logic operations by itself. The substrate 102 transfers current to the glass electrode 1011 through the surface electrode 20 according to a control signal received or generated by the substrate 102 to move droplets on the glass 101, thereby cleaning the glass 101.

The Housing 10

The housing 10 of the package 1 for glass according to the embodiment of the present disclosure has a coupling recess 114 that surrounds the glass 101 and to which the glass 101 is coupled. The housing 10 may include upper and lower housings 11 and 12 combined with each other to form the entire housing 10.

The upper housing 11 has the coupling recess 114. The surface electrode 20 is disposed along the surface of the upper housing 11. The coupling recess 114 may be concave toward the inside of the upper housing 11 or may be formed through the upper housing 11. The body tube 104 having the lens 103 inside and the glass 101 may be positioned or installed in the coupling recess 114. The glass 101 and the lens 103 are disposed in the coupling recess 114 of the upper housing 11 to face the outside to receive light from the outside. The region of the upper housing 11, in which the coupling recess 114 is formed, may be one end 111 of the upper housing 11 that is located in the uppermost position on the drawings. Accordingly, the one end 111 of the upper housing 11 may surround the coupling recess 114.

The upper housing 11, as illustrated in the drawings, may be open at opposite ends thereof in one direction. The upper housing 11 may have an inner surface 113 and an outer surface 112. The outer surface 112 of the upper housing 11 may have a gradually increasing width from the one end 111 to an opposite end 115 of the upper housing 11. The outer surface 112 of the upper housing 11 may be formed with steps that function as stoppers when the upper housing 11 is disposed at a predetermined location of a vehicle or is fastened thereto. However, the shape of the outer surface 112 of the upper housing 11 is not limited thereto.

The lower housing 12 is coupled to the upper housing 11. The lower housing 12 may be coupled to the opposite end 115 of the upper housing 11 that is opposite to the one end 111 of the upper housing 11. Specifically, the region of the upper housing 11 in which the coupling recess 114 is not formed is coupled to the lower housing 12. The upper housing 11 and the lower housing 12 are combined with each other to form an inner space 13 inside. The substrate 102 may be disposed in the inner space 13. In addition to the substrate 102, the body tube 104, and the interconnection wire 105 may be disposed in the inner space 13.

The lower housing 12 may have a gradually decreasing width farther away from one end 121 of the lower housing 12 to which the upper housing 11 is coupled. Accordingly, various components, including the substrate 102, may be disposed in the inner space 13 formed by the one end 121 of the lower housing 12. However, the lower housing 12 may be formed such that only the interconnection wire 105 passes through the space formed by an opposite end 122 of the lower housing 12. As described above in reference to the upper housing 11, the lower housing 12 also may be formed with steps.

The Surface Electrode 20

A method of connecting an electrode of the glass 101 and an electrode of the substrate 102 using a flexible printed circuit board (FPCB) may be considered to connect the glass 101 according to an embodiment of the present disclosure to the substrate 102. However, automation of the manufacturing process is difficult because the FPCB is expensive and the level of difficulty of the process is high.

Accordingly, as in the embodiment of the present disclosure, the surface electrode 20 is formed along the surface of the housing 10. The surface electrode 20 is formed of a conductive material that allows current to flow therethrough. One end 21 of the surface electrode 20 is electrically connected to the glass electrode 1011. An opposite end 22 of the surface electrode 20 is electrically connected to the circuit pattern 1022 of the substrate 102 disposed in the housing 10. Accordingly, the surface electrode 20 electrically connects the substrate 102 and the glass electrode 1011.

Specifically, the surface electrode 20 may be disposed along the outer surface 112 of the upper housing 11. The one end 21 of the surface electrode 20 is disposed on the one end 111 of the upper housing 11 and electrically connected to the glass electrode 1011 through the upper connecting part 106. The surface electrode 20 reaches the opposite end 115 of the upper housing 11 along the outer surface 112 of the upper housing 11. The opposite end 22 of the surface electrode 20 is disposed on the opposite end 115 of the upper housing 11 and electrically connected to the substrate 102, which may is disposed adjacent to the opposite end 115 of the upper housing 11, through a lower connecting part 107.

The upper housing 11 may be formed of a plastic material. The surface electrode 20 may be formed on the surface of the plastic material using a molded interconnect device (MID) or laser direct structuring (LDS) technology. LDS is a method of forming the surface electrode 20 by forming an activated pattern on the surface of a plastic material coated with a special resin using a laser. Plating is then performed on the pattern. However, a method of forming the surface electrode 20 is not limited thereto.

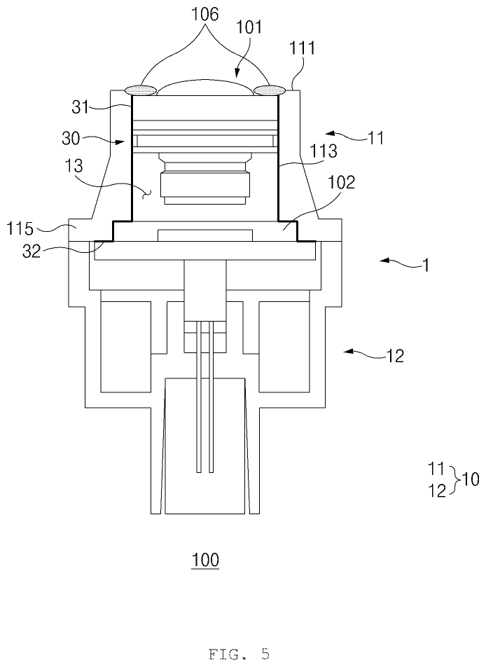

FIG. 5 is a longitudinal sectional view illustrating a modified example of the glass assembly 100 using the package 1 for glass according to the embodiment of the present disclosure.

According to the modified example of the embodiment of the present disclosure, a surface electrode 30 may be disposed along the inner surface 113 of the upper housing 11. The modified example is the same as the embodiment of the present disclosure in that one end 31 of the surface electrode 30 is located on the one end 111 of the upper housing 11 and electrically connected to the glass electrode 1011. An opposite end 32 of the surface electrode 30 is located on the opposite end 115 of the upper housing 11 and electrically connected to the substrate 102, although the surface electrode 30 is disposed on the inner surface 113 of the upper housing 11.

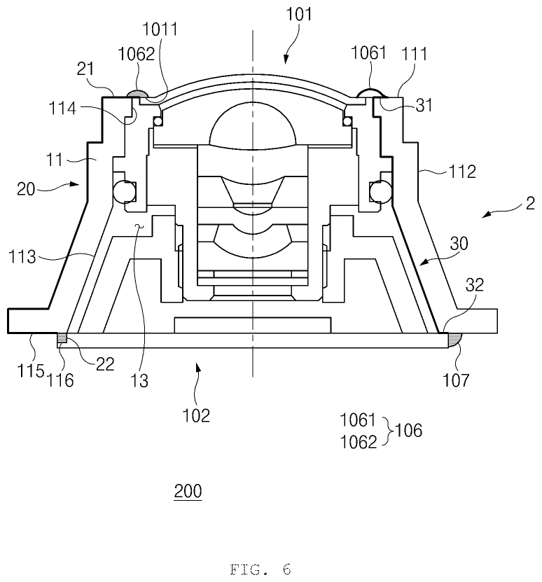

Referring again to FIGS. 1 to 4, the upper connecting part 106 electrically connects the one end 21 of the surface electrode 20 to the glass electrode 1011. The lower connecting part 107 electrically connects the opposite end 22 of the surface electrode 20 to the circuit pattern 1022 of the substrate 102. The upper connecting part 106 may be a silver (Ag) paste that is a conductive paste (1062 of FIG. 6). Alternatively, the upper connecting part 106 may be formed of a metal wire (1061 of FIG. 6), which is a lead formed of metal, to connect the glass electrode 1011 and the one end 21 of the surface electrode 20 by wire bonding. FIG. 3 illustrates an example where wire bonding is used. Since the upper connecting part 106 uses the silver paste or the wire bonding, it is unnecessary to clean flux used to improve the wetting property of solder during soldering. A silver paste or soldering may be used to form the lower connecting part 107.

### Another Embodiment

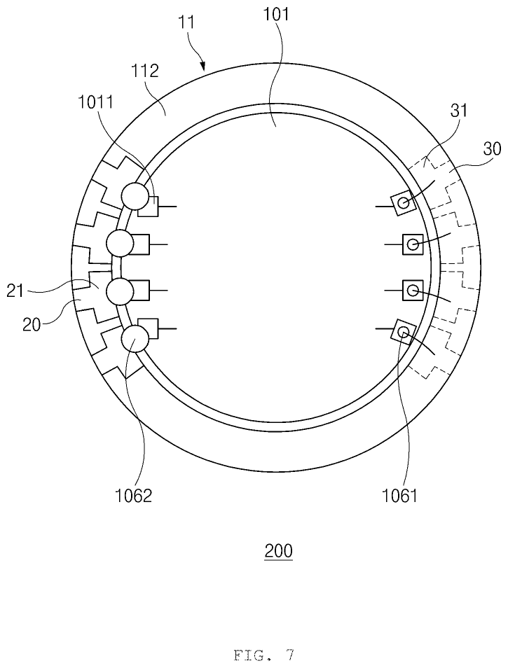

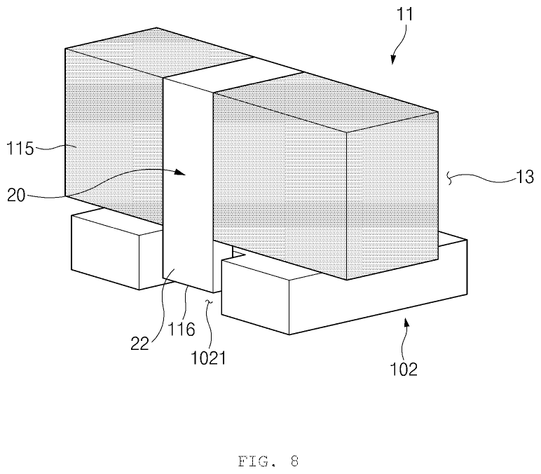

FIG. 6 is a longitudinal sectional view illustrating an upper portion of a glass assembly 200 using a package 2 for glass according to another embodiment of the present disclosure. FIG. 7 is a plan view illustrating the glass assembly 200 using the package 2 for glass according to the other embodiment of the present disclosure. FIG. 8 is a detailed view illustrating a region adjacent to a housing protrusion 116 of the package 2 for glass according to the other embodiment of the present disclosure.

The glass assembly 200 using the package 2 for glass according to the other embodiment of the present disclosure will be described with reference to FIGS. 6 to 8.

The upper housing 11 according to the other embodiment of the present disclosure includes both the surface electrode 20 and the surface electrode 30 described in the embodiment of the present disclosure and the modified example thereof, in which the surface electrode 20 is disposed on the outer surface 112 of the upper housing 11 and the surface electrode 30 is disposed on the inner surface 113 of the upper housing 11. The one end 21 of the surface electrode 20 disposed on the outer surface 112 of the upper housing 11 may be electrically connected to the glass electrode 1011 disposed in one region of the glass 101 through the upper connecting part 106 of one type. The one end 31 of the surface electrode 30 disposed on the inner surface 113 of the upper housing 11 may be electrically connected to the glass electrode 1011 disposed in another region of the glass 101 through the upper connecting part 106 of another type. The upper connecting parts 106 according to the other embodiment of the present disclosure may be one of the conductive paste 1062 or the metal wire 1061 for wire bonding. As illustrated in the drawings, the upper connecting parts 106 may be of different types.

The upper housing 11 according to the other embodiment of the present disclosure includes the housing protrusion 116 that protrudes toward the substrate 102 from a surface of the upper housing 11 that faces the substrate 102. In other words, the housing protrusion 116 protrudes from the opposite end 115 of the upper housing 11 in the direction that the opposite end 115 of the upper housing 11 faces. A plurality of housing protrusions 116 may be formed. For example, as many housing protrusions 116 as the surface electrodes 20 and 30 may be formed.

The housing protrusion 116 may be inserted into a substrate recess 1021 formed through the substrate 102. While FIG. 8 illustrates an example that the substrate recess 1021 is concavely formed at a periphery of the substrate 102, the shape of the substrate recess 1021 is not limited thereto. The upper housing 11 and the substrate 102 may be fixed in place by inserting the housing protrusion 116 into the substrate recess 1021.

The opposite end 22 of the surface electrode 20 may be disposed on the housing protrusion 116. For example, the surface electrode 20 may be disposed along the housing protrusion 116. The opposite end 22 of the surface electrode 20 disposed on the surface of the housing protrusion 116 may be electrically connected to a side surface of the substrate 102 that surrounds the substrate recess 1021. The opposite end 22 of the surface electrode 20 may be electrically connected to the side surface of the substrate 102 through the lower connecting part 107 or may be brought into direct contact with the circuit pattern 1022 of the substrate 102 to make an electrical connection with the substrate 102.

According to the embodiments of the present disclosure, the glass may be self-cleaned without any separate additional components. The glass may be protected and electrically connected to the substrate by a simple structure rather than a complex structure.

Hereinabove, even though all of the components are coupled into one body or operate in a combined state in the description of the above-mentioned embodiments of the present disclosure, the present disclosure is not limited to these embodiments. All of the components may operate in one or more selective combination within the range of the purpose of the present disclosure. It should be also understood that the terms of “include”, “comprise”, or “have” in the specification are “open type” expressions just to say that the corresponding components exit and, unless specifically described to the contrary, do not exclude, but may include, additional components. Unless otherwise defined, all terms used herein, including technical and scientific terms, have the same meaning as those generally understood by those skilled in the art to which the present disclosure pertains. Such terms as those defined in a generally used dictionary are to be interpreted as having meanings equal to the contextual meanings in the relevant field of art and are not to be interpreted as having ideal or excessively formal meanings unless clearly defined as having such in the present application.

Although the present disclosure has been described with reference to embodiments and the accompanying drawings herein, the present disclosure is not limited thereto and may be variously modified and altered by those skilled in the art to which the present disclosure pertains without departing from the spirit and scope of the present disclosure claimed in the following claims. Therefore, the embodiments of the present disclosure are provided to explain the spirit and scope of the present disclosure, so that the spirit and scope of the present disclosure is not limited by the embodiments. The scope of the present disclosure should be construed on the basis of the accompanying claims and all the technical ideas within the scope equivalent to the claims should be included in the scope of the present disclosure.

What is claimed is:

1. A package for glass, the package comprising:
a housing comprising a coupling recess configured to surround a transparent glass such that the transparent glass is coupled to the coupling recess, the transparent glass including a glass electrode through which current flows; and
a surface electrode formed along the housing, the surface electrode being formed of a conductive material,
wherein one end of the surface electrode is electrically connected to the glass electrode and an opposite end of the surface electrode is electrically connected to a substrate disposed in the housing to electrically connect the substrate and the glass electrode.

2. The package of claim 1, wherein the housing further comprises:
an upper housing having the coupling recess and a surface along which the surface electrode is disposed.

3. The package of claim 2, wherein the housing further comprises:
a lower housing configured to surround an inner region, in which the substrate is disposed, together with the upper housing, wherein a region of the upper housing in which the coupling recess is not formed is coupled to the lower housing.

4. The package of claim 2, wherein the surface electrode is disposed along an outer surface of the upper housing.

5. The package of claim 2, wherein the surface electrode is disposed along an inner surface of the upper housing.

6. The package of claim 2, wherein the upper housing includes a housing protrusion that protrudes toward the substrate from a surface of the upper housing that faces the substrate, and
wherein the housing protrusion is configured to be inserted into a substrate recess formed through the substrate.

7. The package of claim 6, wherein the opposite end of the surface electrode is disposed on the housing protrusion and electrically connected to a side surface of the substrate that surrounds the substrate recess.

8. The package of claim 1, wherein the glass electrode and the one end of the surface electrode are connected by wire bonding using a metal wire or a conductive paste to make an electrical connection therebetween.

9. The package of claim 8, wherein the conductive paste is a silver (Ag) paste.

10. A glass assembly comprising:
transparent glass including a glass electrode through which current flows;
a housing combined with the transparent glass;
a substrate disposed in the housing; and
a surface electrode formed along the housing and brought into contact with the glass electrode and the substrate to electrically connect the glass electrode and the substrate.
